(19) United States
(12) Patent Application Publication
(10) Pub. No.: US 2010/0301261 A1
(43) Pub. Date: Dec. 2, 2010

(54) ELECTROMAGNETIC WAVE ABSORBING AND HEAT DISSIPATION MATERIAL

(75) Inventor: WEN-KAI CHIANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/493,149

(22) Filed: Jun. 26, 2009

(30) Foreign Application Priority Data
May 31, 2009 (CN) 200910302794.6

(51) Int. Cl. C09K 5/14

(52) U.S. Cl. 252/75; 252/78.3

(57) ABSTRACT

An electromagnetic wave absorbing and heat dissipation material includes thermal conductive grains, electromagnetic wave absorbing particles, and thermal conductive adhesive to bond the thermal conductive grains and the electromagnetic wave absorbing particles together. Weight of the thermal conductive grains accounts for total weight of the electromagnetic wave absorbing and heat dissipation material in a range from about 15% to about 25%, weight of the electromagnetic wave absorbing particles accounts for the total weight of the electromagnetic wave absorbing and heat dissipation material in a range from about 25% to about 30%, and weight of the thermal conductive adhesive accounts for the total weight of the electromagnetic wave absorbing and heat dissipation material in a range from about 50% to about 60%.

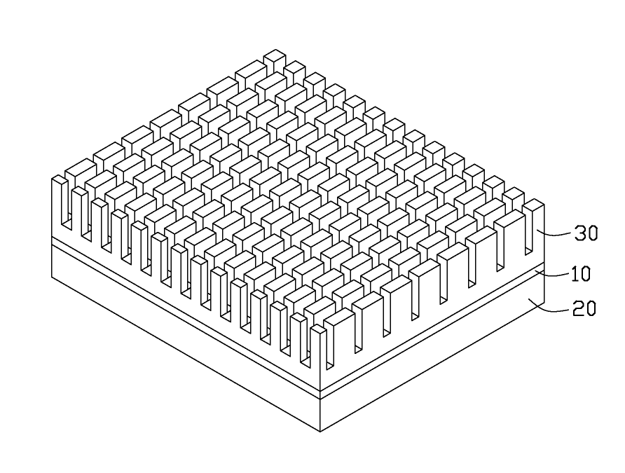

### BACKGROUND

1. Technical Field

The present disclosure relates to an electromagnetic wave absorbing and heat dissipation material.

2. Description of Related Art

In recent years, operating frequencies of electronic elements, such as central processing units of electronic devices, have rapidly increased, resulting in undesirable heat and electromagnetic radiation. The heat must be dissipated quickly to prevent overheating of the electronic elements, and the electromagnetic radiation must be absorbed timely to prevent damage to people.

Heat sinks are commonly used to dissipate heat from electronic elements. Heat sinks are placed in close contact with the electronic elements in order for heat to be efficiently transferred. Because of height differences among various electronic elements and element tolerances in the assembly process of an electronic device, heat conductive greases are often placed between the electronic elements and the heat sinks, so that heat is transferred from the electronic elements to the heat sinks through the heat conductive grease. However, the heat conductive grease only serve as heat dissipating articles, and lack ability to absorb electromagnetic waves.

### BRIEF DESCRIPTION OF THE DRAWING

The drawing is a schematic diagram of an embodiment of an electromagnetic wave absorbing and heat dissipation material, the electromagnetic wave absorbing and heat dissipation material positioned between an electronic element and a heat sink.

### DETAILED DESCRIPTION

Referring to the drawing, an exemplary embodiment of an electromagnetic wave absorbing and heat dissipation material 10 includes thermal conductive grains, electromagnetic wave absorbing particles, and thermal conductive adhesive to bond the thermal conductive grains and the electromagnetic wave absorbing particles together. In one embodiment, weight of the thermal conductive grains accounts for total weight of the electromagnetic wave absorbing and heat dissipation material 10 in a range from about 15% to about 25%. Weight of the thermal conductive adhesive accounts for the total weight of the electromagnetic wave absorbing and heat dissipation material 10 in a range from about 50% to about 60%. Weight of the electromagnetic wave absorbing particles accounts for the total weight of the electromagnetic wave absorbing and heat dissipation material 10 in a range from about 25% to about 30%.

The thermal conductive grains conduct and absorb heat generated by an electronic element 20, such as a central processing unit, and include graphite grains and metal grains. In one embodiment, weight of the graphite grains accounts for the total weight of the thermal conductive grains in a range from about 5% to about 15%, and weight of the metal grains accounts for the total weight of the thermal conductive grains in a range from about 10% to about 15%. In other embodiments, proportion of the graphite grains and the metal grains in the thermal conductive grains can be adjusted according to actual need, such as, increasing the proportion of the metal grains to enhance thermal conductive. It may be appreciated that the metal grains are a mixture including silver powder and aluminum powder.

The electromagnetic wave absorbing particles are nanometer absorbing particles made by nanometer technology, and are used to absorb electromagnetic waves generated by the electronic element 20. The nanometer absorbing particles are made by magnetic loss absorbing material, dielectric loss absorbing material, or a mixture of the magnetic loss absorbing material and the dielectric loss absorbing material by nanometer technology. In one embodiment, the dielectric loss absorbing material includes graphite and silicon carbide. The magnetic loss absorbing material includes at least one material selected from the group consisting of zinc-chromium ferrite, nickel-zinc ferrite, nickel-copper ferrite, nickel-chromium ferrite, manganese-zinc ferrite, niobium-zinc ferrite, barium ferrite, strontium ferrite, copper ferrite, magnesium-manganese ferrite, cobalt-nickel ferrite, and lithium-manganese ferrite.

In one embodiment, the thermal conductive adhesive is made of polysiloxane compounds, with strong adhesion property and thermal conductive, and commonly used as thermal conductive medium. The thermal conductive adhesive makes the electromagnetic wave absorbing and heat dissipation material 10 have an improved adhesion property to stick the electronic element 20 and a heat sink 30 together.

When the electromagnetic wave absorbing and heat dissipation material 10 is prepared, the thermal conductive grains, the thermal conductive adhesive, and the electromagnetic wave absorbing particles are mixed together in a certain rate complying with the above mentioned ranges, and to be stirred uniformly. In one embodiment, the weight proportion of the thermal conductive grains may be 20%, the weight proportion of the thermal conductive adhesive may be 50%, and the weight proportion of the electromagnetic wave absorbing particles may be 30%.

In use, the electromagnetic wave absorbing and heat dissipation material 10 is sandwiched by the electronic element 20 and the heat sink 30. The electromagnetic wave absorbing and heat dissipation material 10 absorbs heat generated by the electronic element 20 and transfers the heat to the heat sink 30, and also absorbs electromagnetic waves generated by the electronic element 20 to reduce electromagnetic radiations.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An electromagnetic wave absorbing and heat dissipation material, comprising:
thermal conductive grains to conduct and absorb heat;
electromagnetic wave absorbing particles to absorb electromagnetic waves; and
a thermal conductive adhesive to bond the thermal conductive grains and the electromagnetic wave absorbing particles together;
wherein weight of the thermal conductive grains accounts for total weight of the electromagnetic wave absorbing and heat dissipation material in a range from about 15% to about 25%, weight of the electromagnetic wave absorbing particles accounts for the total weight of the electromagnetic wave absorbing and heat dissipation material in a range from about 25% to about 30%, and weight of the thermal conductive adhesive accounts for the total weight of the electromagnetic wave absorbing and heat dissipation material in a range from about 50% to about 60%.

2. The material of claim 1, wherein thermal conductive grains comprise graphite grains and metal grains.

3. The material of claim 2, wherein weight of the graphite grains accounts for total weight of the thermal conductive grains in a range from about 5% to about 15%, and weight of the metal grains accounts for the total weight of the thermal conductive grains in a range from about 10% to about 15%.

4. The material of claim 2, wherein the metal grains are a mixture comprising silver powder and aluminum powder

5. The material of claim 1, wherein the electromagnetic wave absorbing particles are nanometer absorbing particles.

6. The material of claim 5, wherein the nanometer absorbing particles are made by magnetic loss absorbing material.

7. The material of claim 5, wherein the nanometer absorbing particles are made by dielectric loss absorbing material.

8. The material of claim 5, wherein the nanometer absorbing particles are made by a mixture of magnetic loss absorbing material and dielectric loss absorbing material.

9. The material of claim 8, wherein the magnetic loss absorbing material comprises at least one material selected from the group consisting of zinc-chromium ferrite, nickel-zinc ferrite, nickel-copper ferrite, nickel-chromium ferrite, manganese-zinc ferrite, niobium-zinc ferrite, barium ferrite, strontium ferrite, copper ferrite, magnesium-manganese ferrite, cobalt-nickel ferrite, and lithium-manganese ferrite.

10. The material of claim 8, wherein the dielectric loss absorbing material comprises graphite and silicon carbide.
